(19) United States
(12) Patent Application Publication
(10) Pub. No.: US 2026/0310793 A1
(43) Pub. Date: Oct. 8, 2026

(54) SYSTEMS AND METHODS FOR APPLICATION PROGRAMMING INTERFACE ONBOARDING USING HYBRID CONTRACT TESTING

(71) Applicant: Capital One Services, LLC, McLean, VA (US)

(72) Inventor: David Bodin, Larkspur, CA (US)

(73) Assignee: Capital One Services, LLC, McLean, VA (US)

(21) Appl. No.: 19/172,561

(22) Filed: Apr. 7, 2025

(51) Int. Cl. G06F 21/57; G06F 21/53; G06F 21/60

(52) U.S. Cl. CPC G06F 21/577; G06F 21/53; G06F 21/602

(57) ABSTRACT

Systems and methods for application programming interface (“API”) onboarding using hybrid contract testing. For example, the system may receive, by an API provider, a first request for onboarding a first API. The system may generate a containerized proxy. The system may retrieve, using the containerized proxy, a first API contract for the first API. The system may generate, using the containerized proxy, a first set of interactions for the first API contract. The system may generate, using the containerized proxy, a first mock response based on the first set of interactions. The system may determine to onboard the first API based on the first mock response.

### BACKGROUND

Application programming interface (“API”) onboarding is the process of integrating a new user, developer, or system with an API, ensuring that they understand how to use the API efficiently and effectively. It involves providing the necessary documentation, tools, and support to make the integration process as smooth as possible. During API onboarding, developers typically gain access to resources such as API keys, endpoints, usage guidelines, and example code to help them start interacting with the API. Comprehensive documentation is crucial, as it explains the API's features, authentication mechanisms, request and response formats, error handling, and any constraints or limitations. The onboarding process may also include interactive elements, like API testing sandboxes, code samples, or developer portals, which allow users to experiment with the API in a controlled environment. Additionally, some API providers offer onboarding assistance through tutorials, webinars, or customer support to address any questions or technical issues that arise. Effective API onboarding is essential for reducing integration time, minimizing errors, and ensuring that users can successfully leverage the API's capabilities to meet their needs.

### SUMMARY

Systems and methods are described herein for novel uses and/or improvements to API onboarding. In particular, systems and methods are described herein for improved contract testing during API onboarding. Contract testing for onboarding APIs is a type of testing used to ensure that the interactions between different software components, particularly between a consumer (such as a frontend application) and a provider (such as an API), are reliable and adhere to a predefined contract. This “contract” is essentially an agreement that specifies how the API should behave and what data structures, endpoints, and response formats it will provide. The goal of contract testing is to verify that the API meets the expectations of its consumers, ensuring smooth communication and integration, especially during the onboarding of new services or clients.

Systems and methods described herein describe a novel, hybrid contract testing procedure for API onboarding. The hybrid contract testing procedure that is standardized such that, it may be an automated process for multiple users and applications to create and maintain contract tests, which enables rapid adoption of new APIs. To achieve the hybrid contract testing, the systems and methods use a containerized proxy to validate a first API contract provided by an API requestor requesting that a new API be onboarded. For example, the containerized proxy contains data to generate code and run it to create the contract to use as a mock server in the client side tests. By doing so, users do not need to write or maintain code, which would be required for both consumer-driven and bi-directional approaches.

For example, the containerized proxy acts as an intermediary layer that faithfully represents the API contract in a controlled environment, enabling comprehensive validation without requiring direct interaction with the API's underlying code or architecture. By utilizing a containerized setup, the system may provide a novel standardized state convention to detect if a provider has code setup to run as consumer-driven, and if not, uses a free open-source library to compare the contract with an available API specification. This achieves the same result of a schema match without additional coordination that may necessitate a third party, while still enabling the flexibility to let consumers selectively choose which APIs they want more thorough testing (e.g., by re-running code and ensuring stricter guarantees because the code is actually run). Furthermore, the containerized proxy facilitates automated contract testing at scale by being language agnostic and employing a standardized data representation and workflow. For example, the system is language agnostic as the system manages data instead of code-and that data is used in the proxy on the client to generate and run code that produces the contract. Additionally, the provider does not need to rely on code to perform a schema match. Contract testing at scale is thus enabled by the system being language agnostic as will as the state standardization allowing consumers and providers to remain coordinated without communication.

In some aspects, systems and methods for application programming interface (“API”) onboarding using hybrid contract testing are described. For example, the system may receive, by an API provider, a first request for onboarding a first API. The system may generate a containerized proxy. The system may retrieve, using the containerized proxy, a first API contract for the first API. The system may generate, using the containerized proxy, a first set of interactions for the first API contract. The system may generate, using the containerized proxy, a first mock response based on the first set of interactions. The system may determine to onboard the first API based on the first mock response.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative diagram for using containerized proxies to validate API contracts, in accordance with one or more embodiments.

FIG. 2 shows an illustrative diagram for pseudocode to use containerized proxies to validate API contracts, in accordance with one or more embodiments.

FIG. 3 shows illustrative components for a system used to validate API contracts, in accordance with one or more embodiments.

FIG. 4 shows a flowchart of the steps involved in validate API contracts, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

In the context of onboarding APIs, contract testing is critical because it helps to identify and resolve issues early before consumers fully integrate with the API. For example, when a new client or service begins using an API, contract tests can be run to verify that the API delivers data in the expected format and handles requests appropriately. These tests check for correct data schemas, required fields, response codes, and error handling mechanisms, providing a safety net that ensures that any changes or updates to the API do not break existing integrations. By automating contract testing, development teams can facilitate smoother onboarding, reduce the risk of integration failures, and maintain a consistent experience for all API consumers. It also allows for faster and more efficient development cycles by giving both API providers and consumers'confidence that their interactions are functioning as expected.

Existing systems rely on consumer-driven contract testing or bidirectional contract testing. Consumer-driven testing creates an expected result and an API provider re-runs the code to verify whether or not the expectation matches. Bi-directional achieves the same outcome, but with a different process of doing a schema match between a contract and an API specification, which documents API inputs and outputs.

Consumer-driven contract testing and bidirectional contract testing each come with distinct challenges. While consumers create the contract in both the consumer-driven and the bi-directional methods, the challenge with consumer-driven is the amount of work for backend teams to mock data and external systems-which compounds with users declaring structurally similar state with different values-which requires constant coordination. In contrast, bi-directional contract testing alleviates some of the burden for users, but requires additional coordination, typically provided by third parties. For example, the need for both the consumer and the provider to collaborate and agree on a shared contract adds complexity to the process and requires constant coordination, which can be challenging, especially when teams operate independently or have different priorities. The added communication and alignment efforts can slow down development and increase the overall coordination overhead if a third-party intermediary is not used. Additionally, the collaborative nature of bidirectional contract testing may result in compromises that affect the API design. Both sides may need to accommodate each other's requirements, potentially making the API more complex or less efficient. Managing versioning and ensuring backward compatibility further complicate things, as any changes to the contract must be carefully managed to avoid disrupting existing integrations. This often necessitates detailed strategies for version control and phased rollouts to maintain stability while allowing for updates. Both testing approaches, therefore, require careful planning and communication to be successful and must be chosen based on the specific needs and structure of the development teams.

Existing systems rely on consumer-driven contract testing or bidirectional contract testing. Consumer-driven contract testing is a type of contract testing where the consumer of an API defines the expectations for how the provider's API should behave. In this approach, the consumer specifies the exact data and response formats it needs from the API, along with any constraints or rules, and the provider must ensure that the API adheres to these expectations. The focus is on validating that the API can serve the needs of the consumer, even as the API evolves or new features are introduced. This form of testing ensures that changes on the provider side do not inadvertently break the functionality relied upon by the consumer.

Bidirectional contract testing, on the other hand, involves validating both sides of the interaction, the consumer and the provider. Instead of only the consumer defining the contract, both parties collaborate to define the interaction agreements. The provider specifies what it will offer, and the consumer specifies what it expects. Both the consumer's expectations and the provider's guarantees are tested to ensure alignment. This approach ensures a more balanced validation, covering both the needs of the consumer and the constraints of the provider, and provides greater assurance of integration compatibility in systems where both parties have shared responsibilities in the data exchange.

The key difference lies in who defines the contract and how validation is performed. In consumer-driven contract testing, the consumer drives the requirements, and the focus is on ensuring the API serves the consumer's needs. In contrast, bidirectional contract testing involves a more collaborative approach, ensuring that both the consumer's needs and the provider's constraints are respected and tested together. This distinction is important for ensuring that integration issues are minimized and that both sides of an API interaction are thoroughly validated.

Consumer-driven contract testing and bidirectional contract testing each come with distinct challenges. In consumer-driven contract testing, one major problem is the rigidity that can arise when consumers dictate the contract requirements. These consumer-driven demands can be overly specific, making it difficult for the API provider to make updates or improvements without risking compatibility issues. This rigidity can hinder the provider's ability to innovate and evolve the API effectively. Additionally, when there are multiple consumers, managing and testing contracts for each can become complex and burdensome. Each consumer may have different expectations, leading to fragmented API designs and significant testing overhead. This approach can also create a dependency on consumers'needs, limiting the provider's ability to adapt quickly to new requirements or improvements. Moreover, because testing focuses on meeting consumer-defined contracts, there is a risk that edge cases or other important scenarios may be overlooked, leaving potential vulnerabilities or performance issues undetected.

On the other hand, bidirectional contract testing introduces its own set of difficulties. The need for both the consumer and the provider to collaborate and agree on a shared contract adds complexity to the process. This requires constant coordination, which can be challenging, especially when teams operate independently or have different priorities. The added communication and alignment efforts can slow down development and increase the overall coordination overhead. Additionally, the collaborative nature of bidirectional contract testing may result in compromises that affect the API design. Both sides may need to accommodate each other's requirements, potentially making the API more complex or less efficient. Managing versioning and ensuring backward compatibility further complicate things, as any changes to the contract must be carefully managed to avoid disrupting existing integrations. This often necessitates detailed strategies for version control and phased rollouts to maintain stability while allowing for updates. Both testing approaches, therefore, require careful planning and communication to be successful and must be chosen based on the specific needs and structure of the development teams.

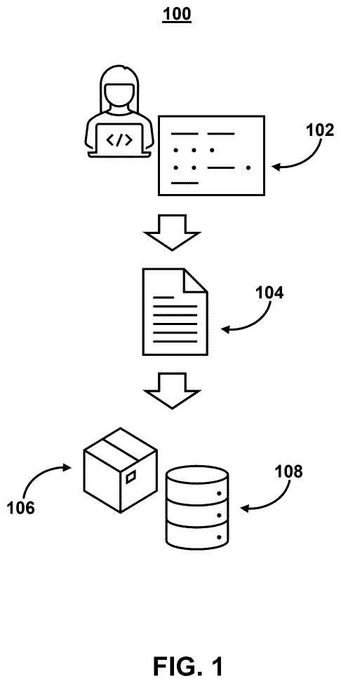

FIG. 1 shows an illustrative diagram for using containerized proxies to validate API contracts, in accordance with one or more embodiments. In particular, FIG. 1 shows system 100, which may use a hybrid contract testing procedure for API onboarding. The hybrid contract testing procedure may enable the benefits of conventional approaches without the drawbacks. For example, system 100 may receive, by an API provider, a first request for onboarding a first API from API requestor 102.

As described herein, an API provider may be an entity or service that develops and offers an API for external use. The API provider makes it possible for other developers, systems, or applications to access and interact with its data, services, or features programmatically. This can include anything from retrieving data from a database, performing complex operations, or enabling communication between different software components. API providers define the endpoints, methods, data formats, and authentication requirements for using their APIs, and they typically maintain the infrastructure and documentation needed to support integration and usage. By offering an API, the provider enables third parties to build applications or services that leverage the provider's functionality, facilitating interoperability, and expanding the reach of the provider's technology.

As described herein, an API requestor may be an entity, such as a developer, organization, or application, that seeks to use or integrate with an API provided by an API provider. The API requestor submits requests to access the API, often initiating the process by asking to onboard the API for use in their projects or systems. For example, a company might act as an API requestor when it submits a request to onboard an API that provides real-time weather data for use in its mobile application. API onboarding may entail the process of granting and configuring access to an API for the requestor. This includes several steps, such as reviewing the API request, setting up authentication mechanisms (like API keys or tokens), verifying that the API is compatible with the requestor's system, and ensuring security and compliance requirements are met. Onboarding may also involve providing the requestor with documentation, sample code, and support to help them integrate the API seamlessly. The goal of API onboarding is to establish a secure and efficient connection between the API provider and the API requestor, ensuring that the API can be used effectively and reliably.

System 100 may provide a standardized and/or automated process for multiple users and applications to create and maintain contract tests, which enables rapid adoption of new APIs. API contract tests may be a type of testing that ensures an API adheres to the predefined specifications outlined in its contract, which is essentially a formal agreement between the API provider and the API consumers (or requestors) about how the API should behave. The contract specifies details such as the available endpoints, request and response formats, data structures, and expected status codes. API contract tests verify that these aspects of the API are implemented correctly and consistently. For example, if the contract states that a specific endpoint should return a JSON object with certain fields, the contract test will check whether the actual response from the API matches this description. These tests help catch any deviations from the agreed-upon behavior, ensuring reliability and preventing breaking changes that could disrupt integrations. By automating contract tests, API providers and requestors can maintain confidence that updates or modifications to the API will not introduce unexpected issues.

To achieve the hybrid contract testing, the systems and methods use a containerized proxy to validate first API contract data (e.g., API contract data 104) provided by an API requestor requesting that a new API be onboarded. In some embodiments, API contract data may refer to the structured information that defines and governs the expected behavior, structure, and interactions of an API between providers and consumers. It serves as a formal agreement outlining what the API should do, how it should respond, and how clients interact with it. API contract data can include various elements, such as API code provided by a user (e.g., a consumer), which specifies functional implementation details, and configuration data supplied by an API provider that defines parameters like endpoints, request limits, authentication rules, or runtime settings. Another example of API contract data includes expectations for code execution, which outline expected inputs, outputs, and behavior when the API is run, helping validate compliance with predefined functional requirements. Additionally, API contract data may include schemas and data models that define the structure of requests and responses, enabling the provider to perform schema matching for validation purposes. It may also incorporate error handling expectations, performance constraints, or versioning information to ensure consistency across updates. Examples of API contract data include OpenAPI or Swagger specifications, JSON Schema definitions, GraphQL schemas, gRPC service definitions, and WSDL files for SOAP APIs. Together, these elements help providers and consumers align on API functionality, validate interoperability, and streamline testing and integration.

For example, a containerized proxy, or proxy sidecar, may be a network proxy that runs alongside an application within a containerized environment, typically as a separate container in the same pod, when using orchestration platforms like Kubernetes. This setup is often referred to as the sidecar pattern, where the proxy container acts as a companion to the main application container. The proxy sidecar intercepts and manages network traffic between the application and external services, handling tasks such as load balancing, encryption, authentication, and monitoring. By decoupling these responsibilities from the main application, a containerized proxy simplifies service management and enhances security, performance, and observability. This setup is commonly used in microservices architectures, where communication between services must be efficient and secure. The sidecar proxy can be configured to enforce policies, manage service discovery, or provide insights into network traffic, all while maintaining isolation from the main application container.

System 100 may begin by setting up the necessary environment for testing. This includes loading configuration files, state files, and mock data. The environment setup may also involve launching a containerized proxy or mock server to simulate the API's behavior without impacting live systems. Any required external dependencies are mocked or initialized to create a controlled testing environment.

Using a state file, the system configures the state functions to set the required conditions for the API interactions. This could involve setting up mock data in databases, configuring the necessary endpoints, or initializing any dependencies the API needs to function. The system ensures that the API is in a predictable state, making it ready for consistent testing.

System 100 may submit API contract 104 to containerized proxy 106 for API provider 108. Containerized proxy 106 may act as an intermediary layer that faithfully represents API contract 104 to in a controlled environment, enabling comprehensive validation without requiring direct interaction with the API's underlying code or architecture. By utilizing a containerized setup, the system ensures that testing is conducted in a language-agnostic and data-driven manner, meaning that the proxy manages all requests and responses based on the API contract specifications, abstracting away the complexities of different programming languages or technology stacks. This ensures a consistent testing experience for every user and application, simplifying integration and reducing potential compatibility issues.

Containerized proxy 106 facilitates automated contract testing at scale by employing a standardized data representation and workflow. This uniformity allows the system to efficiently handle multiple API contracts simultaneously, ensuring that the validation process is robust and repeatable across different environments. By centralizing updates to the proxy, the system can seamlessly implement future enhancements or changes, ensuring that all users benefit from improvements without disrupting the testing process. Additionally, the proxy helps prevent the challenges associated with bidirectional and consumer-driven contract testing, as it isolates the contract validation from the complexities of real-time communication between services. The proxy's capability to abstract the API's internal details while adhering strictly to the contract specifications allows for a simplified and reliable validation process, minimizing risks and ensuring compliance with the expected API behavior for all stakeholders.

The system generates and sends a series of API requests based on the contract's specifications. These requests are executed using predefined parameters, such as HTTP methods, headers, and request bodies. The containerized proxy or CLI tool may be used to facilitate and capture these interactions, ensuring that all requests follow the contract's structure.

As the API requests are executed, the system generates mock responses that simulate how the API should behave according to the contract. These responses are compared with the actual responses received from the API. The system may use matcher functions to perform this comparison, verifying the content, data structure, and status codes to ensure compliance with the contract. The system performs a detailed analysis to compare the mock responses against the actual API responses. This involves checking for any discrepancies, such as mismatched data formats, incorrect status codes, or unexpected variations in the response payload. The validation process ensures that the API's implementation matches the agreed-upon contract. If any discrepancies are found during the comparison, the system logs the details, including what was expected versus what was received. The results of the test, whether successful or failed, are documented in a report. This report may include recommendations for updates or fixes needed to bring the API into compliance with the contract.

The system generates notifications to inform relevant stakeholders about the outcome of the contract test. If issues are identified, the system may provide recommendations for adjustments, such as modifying endpoints, updating authentication protocols, or correcting data structures. These notifications ensure that everyone involved in the onboarding process is aware of any required actions.

System 100 may generate notifications about an API onboarding process to keep all relevant stakeholders informed about the status, requirements, and any issues that arise during the integration. These notifications can include various types of updates, such as confirmation messages when an onboarding request is received, alerts if discrepancies are detected between the API and expected specifications, or reminders about pending actions needed to complete the onboarding. The notifications may be sent through multiple channels, such as email, dashboards, or integrated messaging systems, to ensure timely communication.

The content of these notifications often includes specific details about the onboarding process, such as the success or failure of contract tests, required changes to the API, or security measures that must be implemented. The system may provide recommendations to the API requestor, such as optimizing data structures, updating endpoints to meet performance standards, or modifying authentication mechanisms to enhance security. Additionally, if updates to the API contract are needed, the notifications may include guidelines for aligning the API's implementation with the system's integration requirements. By delivering these notifications and recommendations, the system facilitates smoother API onboarding and helps maintain compliance, performance, and security standards.

System 100 may generate a notification on a user interface. As referred to herein, a “user interface” may comprise a human-computer interaction and communication in a device, and may include display screens, keyboards, a mouse, and the appearance of a desktop. For example, a user interface may comprise a way a user interacts with an application or a website.

As referred to herein, “content” should be understood to mean an electronically consumable user asset, such as Internet content (e.g., streaming content, downloadable content, Webcasts, etc.), video clips, audio, content information, pictures, rotating images, documents, playlists, websites, articles, books, electronic books, blogs, advertisements, chat sessions, social media content, applications, games, and/or any other media or multimedia and/or combination of the same. Content may be recorded, played, displayed, or accessed by user devices, but can also be part of a live performance. Furthermore, user generated content may include content created and/or consumed by a user. For example, user generated content may include content created by another, but consumed and/or published by the user.

The system may monitor content generated by the user to generate user profile data. As referred to herein, “a user profile” and/or “user profile data” may comprise data actively and/or passively collected about a user. For example, the user profile data may comprise content generated by the user and a user characteristic for the user. A user profile may be content consumed and/or created by a user.

User profile data may also include a user characteristic. As referred to herein, “a user characteristic,” may include information about a user and/or information included in a directory of stored user settings, preferences, and information for the user. For example, a user profile may have the settings for the user's installed programs and operating system. In some embodiments, the user profile may be a visual display of personal data associated with a specific user, or a customized desktop environment. In some embodiments, the user profile may be digital representation of a person's identity. The data in the user profile may be generated based on the system actively or passively monitoring.

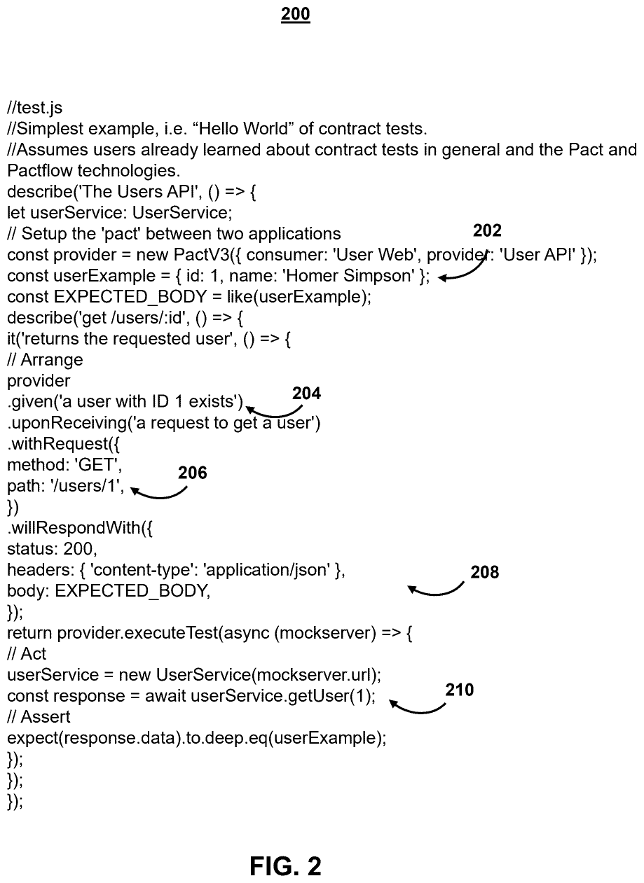

FIG. 2 shows an illustrative diagram for pseudocode. In some embodiments, pseudocode 200 may represent code that is executed to gather data and/or other information to validate API contracts. For example, FIG. 2 shows pseudocode 200. Pseudocode 200 may provide for hybrid contract testing. Pseudocode 200 includes code 202 (e.g., providing a matcher function), code 204 (e.g., (e.g., providing a state determination function), code 206 (e.g., providing request data), code 208 (e.g., providing response data), and code 210 (e.g., providing a functional test). It should be noted that pseudocode 200 is illustrative only and different embodiments may use different code and/or retrieve different types of data.

For example, when a function in the pseudocode produces results, these results may be stored in a database or other persistent storage for future use. These results might then be utilized by a provider to test a mock setup, simulating real-world scenarios to ensure that the system behaves as expected. Additionally, the system may use these tests to evaluate the readiness of a contract. If the test succeeds, indicating the contract meets predefined criteria, the system generates the actual contract. This contract is then made available for use by the backend provider, enabling integration with other systems or facilitating real-world operations. Such processes ensure the system's reliability and readiness before deploying it in a live environment.

For example, pseudocode 200 may serve as a conceptual framework for automating and verifying API interactions. That is, the system may generate a file that collects and stores information as indicated in pseudocode 200, even if pseudocode 200 is not used. Pseudocode 200 may comprise one or more components, each responsible for a part of the testing process. For example, code 202 involves providing a matcher function, which is used to compare actual API responses with the expected outputs defined in the API contract. The matcher function checks for consistency in data structures, field values, and response codes, ensuring that the API behaves as specified.

Code 204 includes a state determination function, which assesses the current state of the API or its environment to determine if it is ready for testing. This function might evaluate factors such as authentication status, API version, or service availability to ensure that the system is in a proper state before initiating tests. Code 206 refers to providing request data, which includes the information sent to the API, such as HTTP method, headers, parameters, and body content. This data is essential for simulating realistic interactions with the API.

Code 208 involves providing response data, which is the output received from the API after a request is made. This includes status codes, headers, and the body of the response, all of which are crucial for verifying the API's behavior. Finally, code 210 outlines a functional test, which checks that the API performs its intended operations correctly. Functional tests validate that the API fulfills its use cases, such as successfully retrieving data, updating resources, or performing calculations, while also adhering to the contract specifications. Together, these components enable a comprehensive approach to API contract testing. The system uses the pseudocode to automate and manage the testing process, ensuring that the API meets both functional and contractual requirements, while also allowing for the flexibility needed to accommodate complex or hybrid testing scenarios.

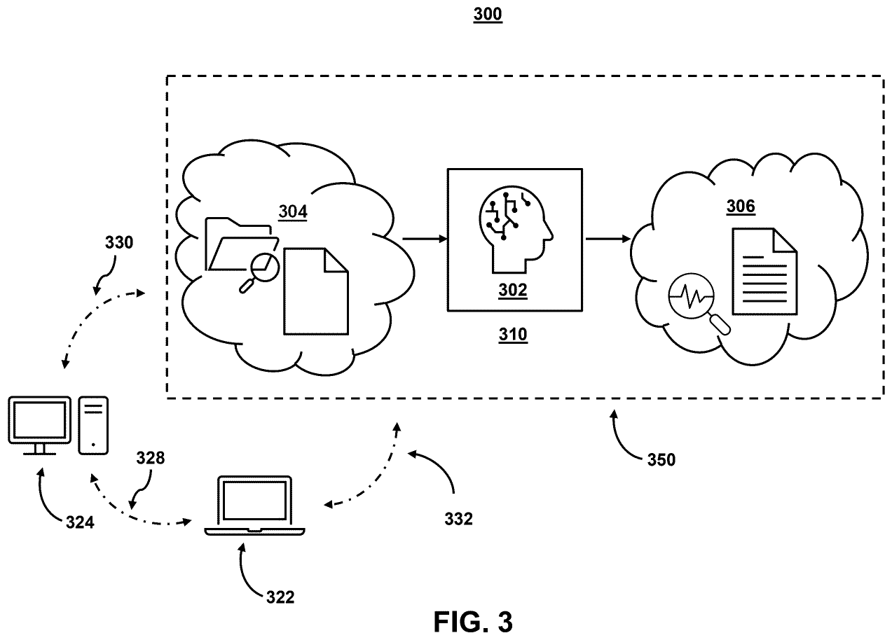

FIG. 3 shows illustrative components for a system used to validate API contracts, in accordance with one or more embodiments. For example, FIG. 3 may show illustrative components for API onboarding using hybrid contract testing. As shown in FIG. 3, system 300 may include mobile device 322 and user terminal 324. While shown as a smartphone and personal computer, respectively, in FIG. 3, it should be noted that mobile device 322 and user terminal 324 may be any computing device, including, but not limited to, a laptop computer, a tablet computer, a hand-held computer, and other computer equipment (e.g., a server), including “smart,” wireless, wearable, and/or mobile devices. FIG. 3 also includes cloud components 310. Cloud components 310 may alternatively be any computing device as described above, and may include any type of mobile terminal, fixed terminal, or other device. For example, cloud components 310 may be implemented as a cloud computing system, and may feature one or more component devices. It should also be noted that system 300 is not limited to three devices. Users may, for instance, utilize one or more devices to interact with one another, one or more servers, or other components of system 300. It should be noted, that, while one or more operations are described herein as being performed by particular components of system 300, these operations may, in some embodiments, be performed by other components of system 300. As an example, while one or more operations are described herein as being performed by components of mobile device 322, these operations may, in some embodiments, be performed by components of cloud components 310. In some embodiments, the various computers and systems described herein may include one or more computing devices that are programmed to perform the described functions. Additionally, or alternatively, multiple users may interact with system 300 and/or one or more components of system 300. For example, in one embodiment, a first user and a second user may interact with system 300 using two different components.

With respect to the components of mobile device 322, user terminal 324, and cloud components 310, each of these devices may receive content and data via input/output (hereinafter “I/O”) paths. Each of these devices may also include processors and/or control circuitry to send and receive commands, requests, and other suitable data using the I/O paths. The control circuitry may comprise any suitable processing, storage, and/or input/output circuitry. Each of these devices may also include a user input interface and/or user output interface (e.g., a display) for use in receiving and displaying data. For example, as shown in FIG. 3, both mobile device 322 and user terminal 324 include a display upon which to display data (e.g., conversational response, queries, and/or notifications).

Additionally, as mobile device 322 and user terminal 324 are shown as touchscreen smartphones, these displays also act as user input interfaces. It should be noted that in some embodiments, the devices may have neither user input interfaces nor displays, and may instead receive and display content using another device (e.g., a dedicated display device, such as a computer screen, and/or a dedicated input device, such as a remote control, mouse, voice input, etc.). Additionally, the devices in system 300 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

In some embodiments, system 300 and/or one or more models herein may be implemented using an application specific integrated circuit. An integrated circuit may be a small electronic device made of semiconductor material, typically silicon, that contains a large number of microscopic electronic components such as transistors, resistors, capacitors, and diodes. These components are interconnected to perform a specific function or set of functions. Integrated circuits can be classified into various types based on their functionality, such as analog, digital, and mixed-signal ICs. The transistors within an IC are the primary building blocks, as they act as switches or amplifiers for electronic signals. The other components, like resistors and capacitors, are used for controlling voltage, current, and timing within the circuit. System 300 may design the integrated circuit to be application specific such that design of the circuit is customized for a given application. In some embodiments, system 300 may use an integrated circuit system where one or more integrated circuit are spread throughout a system, network, and/or one or more devices. In such case, the system design may ensure that the circuits are integrated with other electronic components like connectors, power supplies, and sensors to form a complete and functional electronic system. This integration allows for the implementation of sophisticated tasks in devices needed for one or more specified applications.

FIG. 3 also includes communication paths 328, 330, and 332. Communication paths 328, 330, and 332 may include the Internet, a mobile phone network, a mobile voice, or data network (e.g., a 5G or LTE network), a cable network, a public switched telephone network, or other types of communications networks or combinations of communications networks. Communication paths 328, 330, and 332 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Cloud components 310 may include model 302, which may be a machine learning model, artificial intelligence model, etc. (which may be referred collectively as “models” herein). In recent years, the use of artificial intelligence, including, but not limited to, machine learning, deep learning, etc. (referred to collectively herein as artificial intelligence models, machine learning models, or simply models) has exponentially increased. Broadly described, artificial intelligence refers to a wide-ranging branch of computer science concerned with building smart machines capable of performing tasks that typically require human intelligence. Key benefits of artificial intelligence are its ability to process data, find underlying patterns, and/or perform real-time determinations. However, despite these benefits and despite the wide-ranging number of potential applications, practical implementations of artificial intelligence have been hindered by several technical problems. First, artificial intelligence may rely on large amounts of high-quality data. The process for obtaining this data and ensuring it is high-quality can be complex and time-consuming. Additionally, data that is obtained may need to be categorized and labeled accurately, which can be difficult, time-consuming, and a manual task. Second, despite the mainstream popularity of artificial intelligence, practical implementations of artificial intelligence may require specialized knowledge to design, program, and integrate artificial intelligence-based solutions, which can limit the amount of people and resources available to create these practical implementations. Finally, results based on artificial intelligence can be difficult to review as the process by which the results are made may be unknown or obscured. This obscurity can create hurdles for identifying errors in the results, as well as improving the models providing the results.

Model 302 may take inputs 304 and provide outputs 306. The inputs may include multiple datasets, such as a training dataset and a test dataset. Each of the plurality of datasets (e.g., inputs 304) may include data subsets related to user data, predicted forecasts and/or errors, and/or actual forecasts and/or errors. In some embodiments, outputs 306 may be fed back to model 302 as input to train model 302 (e.g., alone or in conjunction with user indications of the accuracy of outputs 306, labels associated with the inputs, or with other reference feedback information). For example, the system may receive a first labeled feature input, wherein the first labeled feature input is labeled with a known prediction for the first labeled feature input.

In a variety of embodiments, model 302 may update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 302 may be trained to generate better predictions.

In some embodiments, model 302 may include an artificial neural network. In such embodiments, model 302 may include an input layer and one or more hidden layers. Each neural unit of model 302 may be connected with many other neural units of model 302. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 302 may be self-learning and trained, rather than explicitly programmed, and can perform significantly better in certain areas of problem solving, as compared to traditional computer programs. During training, an output layer of model 302 may correspond to a classification of model 302, and an input known to correspond to that classification may be input into an input layer of model 302 during training. During testing, an input without a known classification may be input into the input layer, and a determined classification may be output.

In some embodiments, model 302 may include multiple layers (e.g., where a signal path traverses from front layers to back layers). In some embodiments, back propagation techniques may be utilized by model 302 where forward stimulation is used to reset weights on the “front” neural units. In some embodiments, stimulation, and inhibition for model 302 may be more free-flowing, with connections interacting in a more chaotic and complex fashion. During testing, an output layer of model 302 may indicate whether or not a given input corresponds to a classification of model 302 (e.g., comparing mock responses, API contracts, etc.).

In some embodiments, the model (e.g., model 302) may automatically perform actions based on outputs 306. In some embodiments, the model (e.g., model 302) may not perform any actions. The output of the model (e.g., model 302) may be used to compare mock responses, API contracts, etc.

In some embodiments, the system may generate predictions related to financial services. For example, the system may use one or more models and/or application to process a variety of data to generate predictions for tasks such as payment card eligibility determinations, fraud detection, and/or determining rates for auto-finance applications. For credit card eligibility, the model may use data such as the applicant's credit score, income, employment history, debt-to-income ratio, and past credit history. This data helps the model predict the likelihood of the applicant repaying the credit card debt. For fraud detection, models analyze transaction data, including the amount, location, frequency, and pattern of transactions. They compare these patterns to known fraudulent behavior to identify potentially fraudulent activities. For determining auto-finance rates, models might use the applicant's credit score, loan amount, loan term, vehicle details, and market interest rates. The data used by these models comes from various sources, including credit bureaus, financial institutions, customer-provided information, transaction records, and public records. By analyzing these data points, models can make informed predictions and decisions that help financial institutions manage risk, provide appropriate services, and enhance customer satisfaction.

In some embodiments, the model may process received data through several stages. For example, the model may collect and aggregate data from various sources (e.g., a user account, industry data, third-party data sources, etc.). The system may ensure the data is cleaned and preprocessed to handle any missing and/or inconsistent information. This preprocessing may include normalizing numerical data, encoding categorical variables, and applying techniques to handle outliers. The model may then use feature engineering to identify and create relevant features that can improve its predictive power. For instance, the system may derive new variables from existing ones, such as calculating the debt-to-income ratio from debt and income data.

Once the data is prepared, the system feeds the data into the model, which could be an artificial intelligence algorithm such as logistic regression, decision trees, and/or neural networks. The model may be trained on historical data, learning patterns, and/or relationships between input features and the target outcomes. During this training process, the system may adjust the model parameters to minimize prediction errors. After training, the system may validate the model and test the model using separate data sets to ensure the model has a predetermined and/or threshold accuracy and generalizability.

In some embodiments, the system may use specialized predictions based on the task. Additionally or alternatively, the system may adjust the inputs and/or outputs based on the determinations and/or predictions required. For example, for credit card eligibility, the model may evaluate the applicant's likelihood of defaulting on payments. In fraud detection, the model may identify anomalies and patterns indicative of fraudulent behavior. In auto-finance rate determination, the model may predict the risk associated with lending to an individual and adjusts the interest rates accordingly. In some embodiments, the entire process may be iterative, with models continually updated and refined as new data becomes available, ensuring they remain effective in making accurate and reliable predictions.

System 300 also includes API layer 350. API layer 350 may allow the system to generate summaries across different devices. In some embodiments, API layer 350 may be implemented on mobile device 322 or user terminal 324. Alternatively or additionally, API layer 350 may reside on one or more of cloud components 310. API layer 350 (which may be A REST or Web services API layer) may provide a decoupled interface to data and/or functionality of one or more applications. API layer 350 may provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 350 may use various architectural arrangements. For example, system 300 may be partially based on API layer 350, such that there is strong adoption of SOAP and RESTful Web-services, using resources like Service Repository and Developer Portal, but with low governance, standardization, and separation of concerns. Alternatively, system 300 may be fully based on API layer 350, such that separation of concerns between layers like API layer 350, services, and applications are in place.

In some embodiments, the system architecture may use a microservice approach. Such systems may use two types of layers: Front-End Layer and Back-End Layer, where microservices reside. In this kind of architecture, the role of the API layer 350 may provide integration between Front-End and Back-End. In such cases, API layer 350 may use RESTful APIs (exposition to front-end or even communication between microservices). API layer 350 may use AMQP (e.g., Kafka, RabbitMQ, etc.). API layer 350 may use incipient usage of new communications protocols such as gRPC, Thrift, etc.

In some embodiments, the system architecture may use an open API approach. In such cases, API layer 350 may use commercial or open source API Platforms and their modules. API layer 350 may use a developer portal. API layer 350 may use strong security constraints applying WAF and DDoS protection, and API layer 350 may use RESTful APIs as standard for external integration.

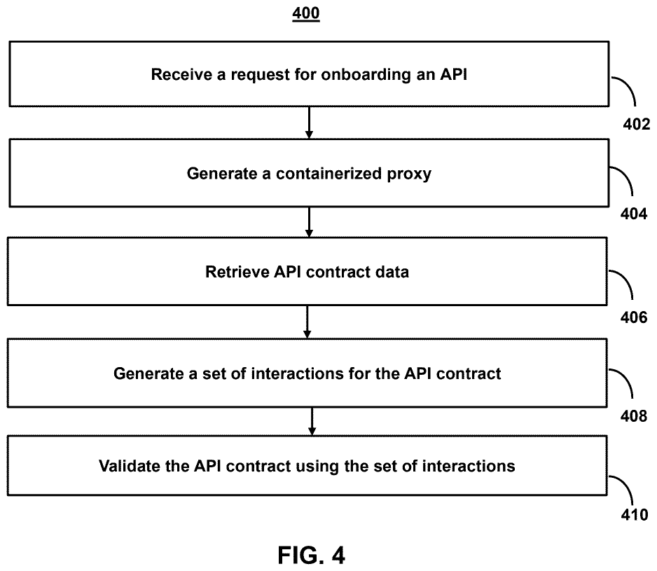

FIG. 4 shows a flowchart of the steps involved in validate API contracts, in accordance with one or more embodiments. For example, the system may use process 400 (e.g., as implemented on one or more system components described above) in provide secure application programming interface (“API”) onboarding to cloud computing networks using hybrid contract testing.

At step 402, process 400 (e.g., using one or more components described above) receives a request for onboarding an API. For example, the system may receive, by an API provider, a first request for onboarding a first API. For example, an API provider is an entity or service that creates and maintains an API, making it available for external use so other systems or developers can interact with the provider's data or functionality. An API requestor, on the other hand, is an entity or system that seeks to use this API to access or utilize the data and services offered by the API provider. When a system receives a first request for onboarding a new API from an API requestor, the process typically involves the API provider setting up or initiating the steps needed to grant access to the API. This onboarding request may include details such as the purpose of using the API, authentication and authorization requirements, terms of service acknowledgment, and technical specifications. The API provider then reviews and processes the request to ensure compliance with any necessary security and operational guidelines before allowing the API requestor to use the API effectively.

In some embodiments, the system may receive the first request for onboarding the first API by retrieving a first standardized API and comparing the first API to the first standardized API. For example, when a system receives a first request for onboarding the first API, the system begins by retrieving a standardized API model or template that serves as a benchmark for comparison. This standardized API includes a set of predefined specifications, such as data formats, authentication protocols, endpoint structures, and expected behaviors, that conform to the system's integration requirements. The system then compares the first API from the request to this standardized API, examining key elements like endpoint configuration, request and response formats, and compliance with security and performance standards. This comparison helps the system determine whether the first API meets the necessary criteria for integration or if adjustments are needed. If the first API aligns well with the standardized API, the system can proceed with onboarding; otherwise, it may generate feedback or require modifications to ensure compatibility and consistency with the system's expectations.

In some embodiments, the system may receive the first request for onboarding the first API by retrieving a first uniform resource locator for the API provider and validating the first uniform resource locator. For example, when a system receives the first request for onboarding the first API, the system starts by retrieving the uniform resource locator (URL) associated with the API provider. This URL serves as the endpoint through which the system will interact with the API. Once the URL is retrieved, the system proceeds to validate it to ensure its correctness and security. The validation process includes checking that the URL is properly formatted, reachable, and secure—often verifying that it uses HTTPS to ensure encrypted communication. Additionally, the system may perform further checks, such as ensuring the URL points to a trusted domain and does not expose vulnerabilities that could compromise the system's security. If the URL passes these validation steps, the system confirms that the API provider's endpoint is ready for integration, allowing the onboarding process to move forward. If the URL fails validation, the system may reject the request or prompt for corrective action to address any issues before proceeding.

In some embodiments, the system may receive the first request for onboarding the first API by retrieving a first file folder for the API provider and validating the first file folder. For example, when a system receives the first request for onboarding the first API, it retrieves a designated file folder associated with the API provider. This file folder typically contains essential resources and configuration files needed for the API onboarding process, such as documentation, authentication details, schema definitions, and integration scripts. The system then validates the contents of this file folder to ensure that all necessary files are present and correctly structured. Validation involves checking the integrity and accessibility of the files, verifying that file formats conform to expected standards, and ensuring there are no missing or corrupted resources. Additionally, the system may perform security checks to confirm that the files do not contain malicious code or vulnerabilities that could compromise the system. If the file folder passes validation, the system deems the request ready to proceed with onboarding. If issues are found during validation, the system may generate an error message or request additional input to correct the discrepancies before continuing.

At step 404, process 400 (e.g., using one or more components described above) generates a containerized proxy. For example, the system may generate a secured containerized proxy by configuring an encryption or environment variable, determining an API key, and determining an API endpoint at a secured location in the first secured cloud computing environment. To generate a secured containerized proxy for onboarding an API, a system first configures encryption and environment variables to ensure data security and proper handling of sensitive information. This involves setting up secure storage mechanisms for these variables, such as using secrets management services, to safeguard sensitive details like API keys. The system then determines or generates an API key, a unique identifier used to authenticate the API requestor and manage access to the API. Once the API key is in place, the system identifies the API endpoint, which is the specific URL or address where API requests will be directed. The system then deploys the proxy in a containerized environment, leveraging tools such as Docker or Kubernetes to encapsulate the proxy in a secure, isolated runtime. The entire setup is hosted in a secured cloud computing environment, which provides additional layers of security, such as virtual private networks, firewalls, and encrypted communication channels, ensuring that API interactions remain protected and compliant with security standards.

In some embodiments, the system may generate, using the containerized proxy, a first mock response based on the first set of interactions by executing, using the containerized proxy, a first function for the first API and receiving the first mock response in response to the first function. For example, to generate a first mock response using the containerized proxy, the system begins by executing a predefined function for the first API. This function is designed to simulate interactions outlined in the API contract, such as sending requests to specified endpoints with required parameters and headers. The containerized proxy, which operates in a secure and controlled environment, executes this function, and handles the simulated API calls as if they were actual requests. During this simulation, the proxy uses the defined data structures, expected responses, and behavior specified in the API contract to generate the mock response. The function generates the mock response by mimicking how the real API would behave, producing sample output that adheres to the expected format and content, such as status codes, response headers, and data payloads. This mock response is then captured by the system, providing a representation of what the API interaction would look like under the given conditions, and serves as a benchmark for validating the API or for further development and testing processes.

In some embodiments, the system may generate, using the containerized proxy, the first mock response based on the first set of interactions by verifying that the containerized proxy is running, and in response to verifying that the containerized proxy is running, testing the first API contract. For example, to generate the first mock response using the containerized proxy, the system may first ensure that the proxy is up and running within its secured containerized environment. This verification step may involve checking the container's status, confirming that all necessary services and dependencies are active and functioning correctly. Once the system verifies that the containerized proxy is operational, it proceeds to test the first API contract by executing the set of interactions defined within the contract. These interactions simulate real API calls, including sending requests to specified endpoints and applying any required authentication and data formatting. The containerized proxy handles these simulated interactions, using the information from the API contract to generate appropriate mock responses. The mock response is produced based on the expected outcomes and specifications provided in the contract, ensuring that the system can validate and test the API's behavior in a controlled and secure manner before full onboarding. This process helps identify any potential issues or discrepancies early, maintaining the integrity and reliability of the API integration.

In some embodiments, the system may generate, using the containerized proxy, the first mock response based on the first set of interactions by generating, using the containerized proxy, the first mock response based on the first set of interactions by verifying that the containerized proxy is running, in response to verifying that the containerized proxy is running, testing the first API contract. For example, to generate the first mock response using the containerized proxy, the system may first verify that the proxy is running properly in its secure, containerized environment. This verification step checks whether the containerized services are active and all required components, such as networking and resource management, are functioning without errors. Once the system confirms that the containerized proxy is operational, it moves on to test the first API contract. This involves executing the set of interactions defined in the API contract, which may include sending mock requests to specified endpoints, applying required authentication, and following the outlined data formats. The containerized proxy processes these interactions, generating a mock response based on the specifications and expected behaviors described in the API contract. By testing the API contract in this way, the system ensures that the mock response accurately reflects how the real API is supposed to behave, providing a foundation for validating the API's functionality and reliability before deciding to proceed with onboarding. This comprehensive process ensures that the API can be safely and efficiently integrated into the system.

In some embodiments, the system may generate, using the containerized proxy, the first mock response based on the first set of interactions by determining mock data for generating the first mock response and loading the mock data. For example, to generate the first mock response using the containerized proxy, the system may begin by determining the mock data required for the interactions specified in the API contract. This mock data is selected or generated to match the expected structure, types, and content defined in the API contract, ensuring that it accurately simulates real data the API might handle. Once the appropriate mock data is determined, the system loads this data into the containerized proxy environment. This step involves configuring the proxy to use the mock data as the basis for generating responses to the simulated API requests. The proxy then executes the first set of interactions using this mock data, creating a mock response that mirrors the expected behavior of the actual API. This process ensures that the mock response is realistic and conforms to the specifications outlined in the API contract, enabling effective testing and validation of the API's integration before proceeding with full onboarding.

In some embodiments, the system may generate, using the containerized proxy, the first mock response based on the first set of interactions by determining a required interaction for the first mock response, and determining whether the required interaction is included in the first set of interactions. For example, to generate the first mock response using the containerized proxy, the system starts by identifying the specific interactions necessary to produce a valid mock response based on the API contract. This involves analyzing the requirements of the API contract, such as the specific endpoints that need to be called, the methods (e.g., GET, POST), the expected input parameters, and any authentication protocols. The system then determines whether each required interaction is present in the first set of interactions prepared for testing. If the required interaction is included, the containerized proxy executes the interaction, using mock data and predefined configurations to simulate the API behavior and generate the corresponding mock response. If any required interaction is missing from the set, the system may either flag the issue for further configuration or prompt for additional setup to ensure comprehensive coverage. This approach ensures that all necessary interactions are accounted for and that the generated mock response accurately reflects the API's expected behavior, allowing for reliable testing and validation before onboarding.

At step 406, process 400 (e.g., using one or more components described above) retrieves an API contract data. For example, the system may retrieve, using the secured containerized proxy, first API contract data for a first API contract for the first API, wherein the first API contract data comprises first API code and a first configuration for the first API. The system may then generate the first API contract based on the first API contract data.

For example, the system may retrieve a first API code and a first configuration for the first API by utilizing a containerized proxy that acts as an intermediary between the system and the source of the API artifacts. The proxy, deployed within a containerized environment, ensures portability, scalability, and isolation during the retrieval process. The system may communicate with repositories, version control systems, or configuration management tools to fetch the API code and associated configuration files, which define critical parameters such as endpoints, authentication mechanisms, and operational behaviors. Once retrieved, the system uses the first API code to understand the functional structure and logic of the API while leveraging the first configuration to define runtime constraints, dependencies, and settings. This combination allows the system to analyze and interpret the expected behavior of the API. Based on the API code and configuration, the system generates a first set of interactions, simulating the behavior of clients or systems consuming the API. These interactions align with a predefined first API contract, which specifies input-output expectations, response formats, and interaction rules, ensuring compliance and consistency. The system validates the generated interactions to confirm that they adhere to the first API contract, thereby enabling robust testing, verification, and integration processes.

In some embodiments, the system may retrieve open-source API specifications by accessing public repositories, API specification registries, or version control systems where standardized API definitions, such as those in OpenAPI, Swagger, or RAML formats, are stored. These specifications may describe the structure, endpoints, methods, data models, and expected behaviors of APIs in a machine-readable format. The system, often through automated processes or a containerized proxy, parses and imports these open-source specifications to extract relevant information that can supplement the first API contract. By integrating these open-source specifications, the system enriches the first API contract with additional details such as missing endpoints, standardized request and response formats, error handling schemas, and authentication requirements. This process ensures the contract is more robust, comprehensive, and adheres to widely accepted API practices. The system can then reconcile and merge the open-source specifications with the existing API code and configuration, resolving any inconsistencies and filling gaps in the first API contract. This supplementation enhances interoperability, ensures compliance with industry standards, and streamlines the generation of interactions or tests for validating the API's functionality and behavior.

In some embodiments, the system may retrieve a first API contract. For example, the system may retrieve, using the containerized proxy, a first API contract for the first API. To retrieve the first API contract for the API using the containerized proxy, the system initiates a request from within the secure container environment. The containerized proxy may be configured to handle secure communication with the API provider, utilizing established protocols such as HTTPS to ensure encrypted data transfer. When the request is made, the proxy uses the configured API key and any necessary authentication tokens to verify its identity and gain authorized access to the API contract. The API contract, which outlines the rules, endpoints, methods, data structures, and usage guidelines of the API, is then fetched from the API provider. The containerized proxy handles this interaction securely, ensuring that any exchanged information, such as configuration details or sensitive data, is protected within the confines of the secured cloud environment. Once retrieved, the API contract can be used for further integration or configuration of the API services.

At step 408, process 400 (e.g., using one or more components described above) generates a set of interactions for the API contract. For example, the system may generate, using the containerized proxy, a first set of interactions for the first API contract. To generate a first set of interactions for the API contract using the containerized proxy, the system may begin by parsing the API contract to understand the structure, endpoints, and methods defined within. The containerized proxy uses this information to create a series of standardized requests, which align with the specifications and requirements detailed in the API contract. These interactions can include operations such as sending GET, POST, PUT, or DELETE requests to the appropriate API endpoints, as well as formatting request payloads and headers in accordance with the contract's definitions. The proxy also ensures that any authentication mechanisms, like API keys or tokens, are applied correctly to each interaction. Additionally, the system may implement error handling and response validation processes to manage the results of these interactions, ensuring that responses conform to expected formats and contain valid data. By generating this initial set of interactions, the containerized proxy enables seamless communication and testing with the API while maintaining a secure and efficient environment for integration.

At step 410, process 400 (e.g., using one or more components described above) validates the API contract using the set of interactions. For example, the system may validate, using the containerized proxy, the first API contract by generating a first set of interactions for the first API contract, generating a first mock response based on the first set of interactions, and comparing the first mock response to a first contract response from the first API contract.

In some embodiments, the system may then determine whether to onboard the first API based on validating the first API contract. To validate the first API contract using the containerized proxy, the system may generate a set of interactions as specified by the API contract, which may include various API calls that follow the expected methods, endpoints, and data formats. Once these interactions are created, the system may produce a mock response for each interaction. These mock responses are crafted based on the contract's definitions, including expected status codes, data structures, and example payloads. Simultaneously, the containerized proxy sends the same set of interactions to the actual API to obtain real responses, referred to as contract responses. The system then compares the mock responses to the actual contract responses from the API, checking for discrepancies in structure, data content, status codes, and other key details. This comparison ensures that the API behaves as documented in the contract, validating the API's compliance with the agreed-upon specifications. Any inconsistencies or mismatches are flagged for further review, allowing developers to address potential issues in the API implementation or the contract documentation. This validation process helps maintain API reliability and compatibility within the secured environment of the containerized proxy.

In some embodiments, the system may determine to onboard the first API based on the first mock response by determining a first state used to generate the first mock response and determining whether the first state corresponds to a current state of the API provider. For example, to determine whether to onboard the first API, the system evaluates the first mock response by analyzing the state used to generate this mock response. This involves identifying the initial configuration, environment settings, and data assumptions that defined the first state. The system then compares this first state to the current state of the API provider, which includes examining the provider's present API version, available features, authentication requirements, and any updates or changes that may have occurred since the initial state was established. If the first state aligns with the current state of the API provider—meaning that the assumptions, settings, and data used to generate the mock response are still accurate and consistent with the provider's existing setup—the system concludes that the API is ready for onboarding. Conversely, if there are discrepancies between the first state and the current state, such as changes in the API's structure or behavior, the system may flag these issues for further review or require adjustments before proceeding with onboarding. This process ensures that the API integration will function correctly and efficiently, maintaining consistency between the mock interactions and the live API environment.

In some embodiments, the system may determine to onboard the first API based on the first mock response by determining that a first state used to generate the first mock response corresponds to a current state of the API provider, and in response to determining that the first state corresponds to a current state of the API provider, calling the API provider to onboard the first API. For example, to determine whether to onboard the first API based on the first mock response, the system starts by verifying that the first state used to generate the mock response corresponds to the current state of the API provider. This verification process involves comparing the configuration details, expected data formats, endpoint availability, and any authentication mechanisms defined in the first state with the current conditions of the API provider. If all aspects align—indicating that the API provider has not made changes that would affect compatibility—the system confirms that the states are consistent. Upon this confirmation, the system proceeds to initiate the onboarding process by calling the API provider. This call may involve sending a formal onboarding request, complete with necessary credentials, access permissions, and configuration settings. By doing so, the system ensures that the integration process can proceed smoothly, with the API interactions functioning as expected in a stable and secure environment. This coordinated approach guarantees that the onboarding is aligned with the API provider's current capabilities and requirements.

In some embodiments, the system may determine to onboard the first API based on the first mock response by determining that a first state used to generate the first mock response does not correspond to a current state of the API provider, and in response to determining that the first state does not correspond to a current state of the API provider, returning the first API to a first API requestor. For example, to determine whether to onboard the first API when discrepancies arise, the system assesses whether the first state used to generate the mock response corresponds to the current state of the API provider. This assessment involves checking for differences between the initial conditions—such as API endpoints, data structures, authentication protocols, or any version-specific features used in the first state—and the existing setup of the API provider. If the system finds that these states do not align, indicating that the API provider has undergone changes or updates that render the mock response inaccurate or incompatible, it decides not to proceed with the onboarding. Instead, the system returns the first API to the API requestor, along with relevant details about the identified mismatches or issues. This feedback allows the requestor to make necessary adjustments or updates to accommodate the current state of the API provider before reattempting the onboarding process. By handling the situation this way, the system ensures that only compatible and up-to-date API configurations are onboarded, maintaining integration stability and reliability.

In some embodiments, the system may determine to onboard the first API based on the first mock response by determining that a first state used to generate the first mock response does not correspond to a current state of the API provider, and in response to determining that the first state does not correspond to a current state of the API provider, generating a first log of the first request. When a system evaluates the first mock response and determines that the first state used to generate it does not correspond to the current state of the API provider, it recognizes that discrepancies exist between the expected and actual API conditions. This mismatch could be due to changes in the API provider's configuration, such as updated endpoints, altered data formats, or modified authentication requirements. In response to identifying these inconsistencies, the system decides not to proceed with onboarding the API in its current form. Instead, the system generates a detailed log of the first request, documenting crucial information such as the nature of the discrepancies, the parameters of the initial state, the specific areas where differences were found, and any other relevant metadata. This log serves as a comprehensive record that can be used for troubleshooting, auditing, or informing the API requestor about what went wrong. By creating this log, the system ensures that all issues are well-documented, enabling efficient communication and providing a clear path for resolving the discrepancies before reattempting the onboarding process.

In some embodiments, the system may determine to onboard the first API based on the first mock response by comparing the first mock response to a first contract response from the first API contract, and determining whether the first mock response corresponds to the first contract response. For example, to determine whether to onboard the first API based on the first mock response, the system may perform a comparison between the mock response and the expected contract response outlined in the first API contract. This involves examining key elements such as the structure, data types, status codes, headers, and content of both responses. The system checks for consistency, ensuring that the mock response adheres to all the specifications defined in the contract response, including the format and behavior expected from the API. If the mock response aligns perfectly with the contract response, indicating that the API is functioning as intended and complies with the contract's requirements, the system decides to proceed with onboarding the API. However, if discrepancies are found—such as differences in data format, unexpected status codes, or missing fields—the system may flag these issues and decide not to onboard the API until the inconsistencies are resolved. This comparison step ensures that the API implementation is reliable and meets the agreed-upon standards before being integrated into the system.

In some embodiments, the system may determine to onboard the first API based on the first mock response by determining a first update to the first API based on the first mock response and generating a notification based on the first update. For example, to determine whether to onboard the first API based on the first mock response, the system analyzes the mock response to identify any necessary updates or adjustments required for successful integration. This evaluation may reveal issues such as discrepancies in data structure, unexpected response formats, or missing elements that need to be addressed. If the system determines that a specific update to the first API is needed—such as modifying an endpoint, adjusting authentication protocols, or altering data handling—it documents this update. The system then generates a notification based on the identified update, which may include details about the necessary changes, the reasons for the update, and any actions required by the API provider or requestor. This notification ensures that all relevant parties are informed of the required modifications, enabling them to make the necessary adjustments. If the update is successfully implemented and the mock response aligns with the expected API behavior, the system can proceed with onboarding the API. This process helps maintain a high standard of integration and ensures that the API functions as intended within the system.

It is contemplated that the steps or descriptions of FIG. 4 may be used with any other embodiment of this disclosure. In addition, the steps and descriptions described in relation to FIG. 4 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 4.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:

1. A method for application programming interface (“API”) onboarding using hybrid contract testing.

2. The method of the preceding embodiment, further comprising: receiving, by an API provider, a first request for onboarding a first API; generating a containerized proxy; retrieving, using the containerized proxy, a first API contract for the first API; generating, using the containerized proxy, a first set of interactions for the first API contract; generating, using the containerized proxy, a first mock response based on the first set of interactions; and determining to onboard the first API based on the first mock response.

3. The method of any one of the preceding embodiments, wherein determining to onboard the first API based on the first mock response further comprises: determining a first state used to generate the first mock response; and determining whether the first state corresponds to a current state of the API provider.

4. The method of any one of the preceding embodiments, wherein determining to onboard the first API based on the first mock response further comprises: determining that a first state used to generate the first mock response corresponds to a current state of the API provider; and in response to determining that the first state corresponds to a current state of the API provider, calling the API provider to onboard the first API.

5. The method of any one of the preceding embodiments, wherein determining to onboard the first API based on the first mock response further comprises: determining that a first state used to generate the first mock response does not correspond to a current state of the API provider; and in response to determining that the first state does not correspond to a current state of the API provider, returning the first API to a first API requestor.

6. The method of any one of the preceding embodiments, wherein determining to onboard the first API based on the first mock response further comprises: determining that a first state used to generate the first mock response does not correspond to a current state of the API provider; and in response to determining that the first state does not correspond to a current state of the API provider, generating a first log of the first request.

7. The method of any one of the preceding embodiments, wherein generating, using the containerized proxy, a first mock response based on the first set of interactions further comprises: executing, using the containerized proxy, a first function for the first API; and receiving the first mock response in response to the first function.

8. The method of any one of the preceding embodiments, wherein determining to onboard the first API based on the first mock response further comprises: comparing the first mock response to a first contract response from the first API contract; and determining whether the first mock response corresponds to the first contract response.

9. The method of any one of the preceding embodiments, wherein generating, using the containerized proxy, the first mock response based on the first set of interactions further comprises: verifying that the containerized proxy is running; and in response to verifying that the containerized proxy is running, testing the first API contract.

10. The method of any one of the preceding embodiments, wherein generating, using the containerized proxy, the first mock response based on the first set of interactions further comprises: determining mock data for generating the first mock response; and loading the mock data.

11. The method of any one of the preceding embodiments, wherein generating, using the containerized proxy, the first mock response based on the first set of interactions further comprises: determining a required interaction for the first mock response; and determining whether the required interaction is included in the first set of interactions.

12. The method of any one of the preceding embodiments, wherein receiving the first request for onboarding the first API further comprises: retrieving a first standardized API; and comparing the first API to the first standardized API.

13. The method of any one of the preceding embodiments, wherein receiving the first request for onboarding the first API further comprises: retrieving a first uniform resource locator for the API provider; and validating the first uniform resource locator.

14. The method of any one of the preceding embodiments, wherein receiving the first request for onboarding the first API further comprises: retrieving a first file folder for the API provider; and validating the first file folder.

15. The method of any one of the preceding embodiments, wherein determining to onboard the first API based on the first mock response further comprises: determining a first update to the first API based on the first mock response; and generating a notification based on the first update.

16. One or more non-transitory, computer-readable mediums storing instructions that, when executed by a data processing apparatus, cause the data processing apparatus to perform operations comprising those of any of embodiments 1-16.

17. A system comprising one or more processors; and memory storing instructions that, when executed by the processors, cause the processors to effectuate operations comprising those of any of embodiments 1-16.

18. A system comprising means for performing any of embodiments 1-16.

What is claimed is:

1. A system for secure application programming interface (“API”) onboarding to cloud computing networks using hybrid contract testing, the system comprising:
receiving, by an API provider, a first secured request for onboarding a first API in a first secured cloud computing network;
generating a secured containerized proxy by:
configuring a first encryption variable;
determining a first API key; and
determining a first API endpoint at a secured location in the first secured cloud computing network;
retrieving, using the secured containerized proxy, first API contract data for a first API contract for the first API, wherein the first API contract data comprises first API code and a first configuration for the first API;
generating the first API contract based on the first API contract data;
validating, using the secured containerized proxy, the first API contract by:
generating a first set of interactions for the first API contract;
generating a first mock response based on the first set of interactions; and
comparing the first mock response to a first contract response from the first API contract; and
determining to onboard the first API in the first secured cloud computing network based on validating the first API contract.

2. A method for application programming interface (“API”) onboarding using hybrid contract testing, the method comprising:
receiving, by an API provider, a first request for onboarding a first API;
generating a containerized proxy;
retrieving, using the containerized proxy, first API contract data for a first API contract for the first API;
generating, using the containerized proxy, a first set of interactions for the first API contract;
generating, using the containerized proxy, a first mock response based on the first set of interactions; and
determining to onboard the first API based on the first mock response.

3. The method of claim 2, wherein determining to onboard the first API based on the first mock response further comprises:
determining a first state used to generate the first mock response; and
determining whether the first state corresponds to a current state of the API provider.

4. The method of claim 2, wherein determining to onboard the first API based on the first mock response further comprises:
determining that a first state used to generate the first mock response corresponds to a current state of the API provider; and
in response to determining that the first state corresponds to a current state of the API provider, calling the API provider to onboard the first API.

5. The method of claim 2, wherein determining to onboard the first API based on the first mock response further comprises:
determining that a first state used to generate the first mock response does not correspond to a current state of the API provider; and
in response to determining that the first state does not correspond to a current state of the API provider, returning the first API to a first API requestor.

6. The method of claim 2, wherein determining to onboard the first API based on the first mock response further comprises:
determining that a first state used to generate the first mock response does not correspond to a current state of the API provider; and
in response to determining that the first state does not correspond to a current state of the API provider, generating a first log of the first request.

7. The method of claim 2, wherein generating, using the containerized proxy, a first mock response based on the first set of interactions further comprises:
executing, using the containerized proxy, a first function for the first API; and
receiving the first mock response in response to the first function.

8. The method of claim 2, wherein determining to onboard the first API based on the first mock response further comprises:
comparing the first mock response to a first contract response from the first API contract; and
determining whether the first mock response corresponds to the first contract response.

9. The method of claim 2, wherein generating, using the containerized proxy, the first mock response based on the first set of interactions further comprises:
verifying that the containerized proxy is running; and
in response to verifying that the containerized proxy is running, testing the first API contract.

10. The method of claim 2, wherein generating, using the containerized proxy, the first mock response based on the first set of interactions further comprises:
determining mock data for generating the first mock response; and
loading the mock data.

11. The method of claim 2, wherein generating, using the containerized proxy, the first mock response based on the first set of interactions further comprises:
determining a required interaction for the first mock response; and
determining whether the required interaction is included in the first set of interactions.

12. The method of claim 2, wherein receiving the first request for onboarding the first API further comprises:
retrieving a first standardized API; and
comparing the first API to the first standardized API.

13. The method of claim 2, wherein receiving the first request for onboarding the first API further comprises:
retrieving a first uniform resource locator for the API provider; and
validating the first uniform resource locator.

14. The method of claim 2, wherein receiving the first request for onboarding the first API further comprises:
retrieving a first file folder for the API provider; and
validating the first file folder.

15. The method of claim 2, wherein determining to onboard the first API based on the first mock response further comprises:
determining a first update to the first API based on the first mock response; and
generating a notification based on the first update.

16. One or more non-transitory, computer-readable media, comprising instructions that, when executed by one or more processors, cause operations comprising:
generating a containerized proxy for a first API;
retrieving, using the containerized proxy, first API code and a first configuration for the first API;
generating, using the containerized proxy, a first set of interactions for a first API contract based on the first API code and the first configuration;
validating, using the containerized proxy, the first API contract using the first set of interactions; and
generating a confirmation for the first API based on validating the first API contract.

17. The one or more non-transitory, computer-readable media of claim 16, wherein validating the first API contract using the first set of interactions further comprises:
verifying that the containerized proxy is running; and
in response to verifying that the containerized proxy is running, testing the first API contract.

18. The one or more non-transitory, computer-readable media of claim 16, wherein validating the first API contract using the first set of interactions further comprises:
determining mock data for generating a first mock response; and
loading the mock data.

19. The one or more non-transitory, computer-readable media of claim 16, wherein validating the first API contract using the first set of interactions comprises:
determining a required interaction for validating the first API contract; and
determining whether the required interaction is included in the first set of interactions.

20. The one or more non-transitory, computer-readable media of claim 16, wherein validating the first API contract using the first set of interactions further comprises:
retrieving a first standardized API contract; and
comparing the first API contract to the first standardized API contract.
